(19) United States
(12) Patent Application Publication
(10) Pub. No.: US 2006/0178160 A1
(43) Pub. Date: Aug. 10, 2006

(54) System and method for management of communication rights

(75) Inventors: Martin Hans, Bad Salzdetfurth (DE); Holger Schmidt, Braunschweig (DE); Norbert Schwagmann, Lehe (DE)

Correspondence Address: DICKSTEIN SHAPIRO MORIN & OSHINSKY LLP., 1177 AVENUE OF THE AMERICAS 6TH AVENUE, NEW YORK, NY, 10036-1400, US

(73) Assignee: Infineon Technologies AG, Munich (DE)

(21) Appl. No.: 11/323,470

(22) Filed: Dec. 29, 2005

(30) Foreign Application Priority Data
Dec. 29, 2004 (DE) 10 2004 063 298.7

(51) Int. Cl. H04B 7/00

(52) U.S. Cl. 455/518

(57) ABSTRACT

A system and method for managing the communication rights of communication media groups such as audio, video, and text data streams, as well as the communication rights of a plurality of telecommunication devices participating in a telecommunication conference is provided. The communication rights of the telecommunication devices are managed in the course of the telecommunication conference taking into account the communication media group, using a control communication protocol for controlling a real-time data transmission communication protocol.

### CROSS-REFERENCE TO RELATED APPLICATION

This application claims priority to German Patent Application Serial No. 10 2004 063 298.7, which was filed on Dec. 29, 2004, and is incorporated herein by reference in its entirety.

### FIELD OF THE INVENTION

The invention relates to a system and method for computer-aided management of communication rights for communication by means of a plurality of different communication media in a telecommunication conference having a plurality of telecommunication devices.

### BACKGROUND OF THE INVENTION

There is frequently a need to provide communication between a plurality of users with the aid of telecommunication devices, with this communication being handled by means of a telecommunication conference system.

For organized communication, a communication right for the transmission of a specific medium, for example audio data, video data or text data, is in general not allocated to all of the conference participants at the same time. The communication rights are allocated in accordance with specific rules. Control of the communication right allocation is also referred to as floor control, while the rules for communication right allocation are called floor policy.

The communication right for a communication medium such as audio or video is the right to transmit using the communication medium. In other words, a communication right is the right to transmit a data stream for the selected communication medium.

According to the prior art, systems which provide the conference participants with a plurality of microphones and loudspeakers for spoken communication are used in conference rooms. The microphone which is provided for a conference participant must be activated or switched on by the respective subscriber for communication. A microphone which has been activated or switched on blocks all the other microphones in the conference system, so that only one speaker or subscriber is active at any one time. According to one embodiment, a further microphone, for example that of a conference participant who is controlling the conference, may also be active. The communication right is only granted to one conference participant, and if required, to that conference participant who is controlling the conference.

Comparable telecommunication conference systems and services likewise exist for mobile telecommunication devices, mobile telephones. One example of this is the “Direct Connect” PTT service from the Nextel Company, which is known from the United States of America. When using this service, a conference participant has to operate a key which is designed for this purpose on his mobile telephone, as in the case of “walkie-talkies”, in order to transmit messages, with the transmission of messages from other conference participants being blocked during this time period.

Telecommunication conference systems can also be controlled by means of more complex communication right allocation. For example, a conference participant may always be granted a communication right following a communication right for another conference participant, or it is possible to provide for three and only three conference participants to be granted a communication right at the same time. In general and in this specific context, the communication rights can be allocated by a human or machine conference control unit, the so-called moderator.

On the basis of telecommunication systems, communication rights can be allocated and granted for different communication means, for example audio data, video data or text data, with the communication rights for different communication means being allocated separately.

The Internet Engineering Task Force (IETF) have developed a standard for conference systems, in which the communication rights for communication media are controlled by means of the session initiation protocol (SIP) or the simple object access protocol (SOAP) as described in Use of Session Initiation protocol (SIP) and Simple Object Access protocol (SOAP) for Conference Floor Control to Wu et al., IETF Internet-Draft, March 2003 (“Wu”), or by means of the binary floor control protocol (BFCP), as described in The Binary Floor Control Protocol (BFCP) to Camarillo et al., Internet-Draft, October 2004.

In current push-to-talk systems (PTT systems), the communication rights are requested and allocated by means of the real time transport control protocol (RTCP), as described in RTP: A Transport Protocol for Real-Time Applications to Schulzrinne et al., IETF Request For Comments RFC 3550, July 2003 (“RFC 3550”). In contrast to SIP messages, RTCP messages allow smaller amounts of data to be transmitted. RTCP messages are thus more suitable for mobile applications, in particular for telecommunication applications such as mobile radio.

According to the IETF Standard, the real-time transport control protocol is based on periodic transmission of control packets, which are transmitted to all the participants in a conference or telecommunication conference, with the same distribution mechanisms being used for the transmission of the control packets as for the transmission of the payload data for a communication medium.

The payload data for the respective communication medium is transmitted by the real-time transport protocol (RTP), as described in RFC 3550, with the RTP providing an end-to-end network transport function for the transmission of payload data in real time. Furthermore, the real-time transport protocol can be used to transmit audio data, video data or text data via a multicast or unicast network.

The communication media to be transmitted are described using the session description protocol (SDP) in accordance with the standard that has been developed by the IETF for telecommunication conference systems, such as current PTT systems. The media characteristics are negotiated by interchanging SDP messages with the aid of the session initiation protocol (SIP).

The session initiation protocol on the one hand describes the information which is required for taking part in a telecommunication conference, such as the conference address and specific conference information authorizing potential participants to take part in a conference.

The SDP describes the name and the purpose of the conference, the communication media which are available for the time period of the active conference, and information for reception of these communication media that are provided for this conference. This communication media definition or description defines the type of communication medium, for example audio, video or text, the transport protocol for the transmission of a communication medium, for example RTP, User Datagram Protocol (UDP) or Internet Protocol (IP), and the format of the communication medium to be transmitted, for example the H.261 video format or the MPEG video format.

The communication media can also be combined to form groups by means of SDP. The communication media are allocated identifications, and these identifications are collated in a list. According to this IETF Standard, integer numbers are allocated as identifications for the communication media. These communication media identifications, which are stated in the list, can be used for grouping the communication media, with this grouping being carried out on a static basis, that is to say communication rights can be requested and allocated only for previously defined or stipulated communication media groups.

Furthermore, the conference participants can be informed about the state of the conference by means of so-called notification messages. According to an IETF Standard these notification messages are transmitted by means of the session initiation protocol (SIP). Those taking part in a conference can thus be informed of which other conference participants have requested a communication right for a specific communication medium.

In current PTT systems, the conference participants are notified about the events of communication right allocation by means of the real-time transport control protocol (RTCP).

Although the current PTT systems use RTCP for communication right allocation, the current PTT systems are unable to use RTCP for forming communication media groups. Furthermore, it is not possible to request communication rights for communication media groups by means of SIP in conference systems based on an IETF Standard.

Currently in conference systems based on the IETF Standard, the communication rights can only be requested exclusively for predefined communication media groups.

Dynamic selection of the communication media requested by a communication right request or dynamic grouping of the communication media is not possible in accordance with the IETF Standard.

U.S. Patent Publication No. 2004/0057449 A1 describes a method for controlling a communication media group, in which the NBS media signaling protocol is used for control purposes.

Furthermore, U.S. Patent Publication No. 2002/0077136 A1 describes a floor control method in which the floor control is allocated as a function of priorities which are assigned to the telecommunication terminals.

### SUMMARY OF THE INVENTION

A method is provided for computer-aided management of communication rights for communication using a plurality of different communication media in a telecommunication conference having a plurality of telecommunication devices. The communication media are grouped to form at least one communication media group and the communication rights of the telecommunication devices are managed in the course of the telecommunication conference taking into account the communication media group, using a control communication protocol for controlling a real-time data transmission communication protocol. A communication media group which has been formed for the communication media is controlled, and the communication rights of the telecommunication devices are managed, in the course of the telecommunication conference taking into account the communication media group, using a control communication protocol for controlling a real-time data transmission communication protocol.

Furthermore, the real-time data transmission communication protocol is based, for example, on a transport layer communication link.

The transport layer communication link is, for example, a user datagram protocol communication link or a transport control protocol communication link.

By way of example, the real-time transport protocol is used as the real-time data transmission communication protocol.

Furthermore, according to one aspect of the invention, the real-time transport control protocol is used as the communication protocol for controlling the real-time transport protocol.

By way of example, connections are set up for subscribers using the conference system in accordance with a call control protocol, in which case the call control protocol is preferably the session initiation protocol.

The format of a communication media group is defined, for example, in accordance with the session description protocol format.

By way of example, each communication medium is allocated communication medium prioritization information.

By way of example, a real-time data transmission communication protocol communication link is set up for each communication medium that is used, with a control communication protocol data stream being set up for each real-time data transmission communication protocol communication link.

The control communication protocol data for management of a communication media group is transmitted, for example, via one and only one of the plurality of control communication protocol data streams.

The communication media are, for example, audio data, video data or text data.

At least some of the telecommunication devices are, for example, mobile radio terminals, with at least some of the telecommunication devices being 3GPP mobile radio terminals.

Furthermore, a telecommunication conference server device is provided for management of communication rights for communication by means of a plurality of different communication media in a telecommunication conference having a plurality of telecommunication devices.

The telecommunication conference server device is designed in such a way that a real-time data transmission communication protocol is carried out by means of a first communication protocol device.

Furthermore, a control communication protocol for controlling the real-time data transmission communication protocol is carried out by means of a second communication protocol device for the telecommunication conference server device.

According to one aspect of the invention, the communication media are grouped by a communication media group management unit for the telecommunication conference server device, which communication media group management unit is designed for grouping the communication media to form at least one communication media group and/or for controlling a communication media group which has been formed for the communication media, with the communication media group being grouped and controlled using the control communication protocol for controlling the real-time data transmission communication protocol.

Furthermore, the telecommunication conference server device has a communication right management unit which is designed such that the communication rights of the telecommunication devices are managed in the course of the telecommunication conference, taking into account the at least one communication media group.

One aspect of the invention can clearly be regarded as being that the signaling options which are permissible in accordance with the standards for telecommunication systems, for example the IETF Standard or the 3rd Generation Partnership Project (3GPP) Standard, are used on the basis of the RTP and the RTCP, or are extended as permissible within the scope of the standard in order to achieve a functionality which is novel in comparison to the prior art.

In particular, it is possible to overcome the difficulties as described above in the grouping of communication media, since the communication media groups can be defined or controlled dynamically during the conference using RTCP in the same way as the communication for the respective communication media group. Furthermore, the use of RTCP reduces the amount of data to be transmitted for a message during a conference, thus reducing errors and the transmission time required for the communication right control commands.

By way of example, the communication rights are controlled using control commands that are transmitted by means of RTCP, in which case the RTCP stream is used to transmit a single communication medium, which has previously been defined for this purpose, in the communication media group to be controlled. The RTCP stream for the communication medium can be controlled by means of the lowest communication media identification.

This solution has the advantage that communication media group communication rights can also be controlled in systems such as PTT systems which use RTCP for communication right allocation.

Furthermore, as an alternative to communication media grouping, the actual grouping can also be transmitted with the control command before a first communication right control command. The communication media identifications are allocated before the first communication right control command using the session description protocol or the real-time transport protocol. This has the advantage that the communication media groups to be requested can be selected

dynamically for each communication right request. The described refinements of the invention, which are described in conjunction with the method that is provided, also apply to the telecommunication conference server unit that is provided.

### BRIEF DESCRIPTION OF THE DRAWINGS

Exemplary embodiments of the invention are illustrated in the figures and will be explained in the following text, with identical components often being provided with the same reference symbols.

FIG. 1 shows an architecture of a centrally controlled telecommunication conference according to one exemplary embodiment of the invention.

FIG. 2 shows a message flowchart for an offer-answer model by means of the session initiation protocol SIP.

FIG. 3 shows a communication media description by means of the session description protocol SDP.

FIG. 4 shows a real-time transport control protocol (RTCP) message for a communication right request according to one exemplary embodiment of the invention.

FIG. 5 shows a message flowchart for communication right control.

FIG. 6 shows an extended real-time transport control protocol message for a communication right request according to a second exemplary embodiment of the invention.

### DETAILED DESCRIPTION OF THE PREFERRED EMBODIMENTS OF THE INVENTION

### Exemplary Embodiment 1

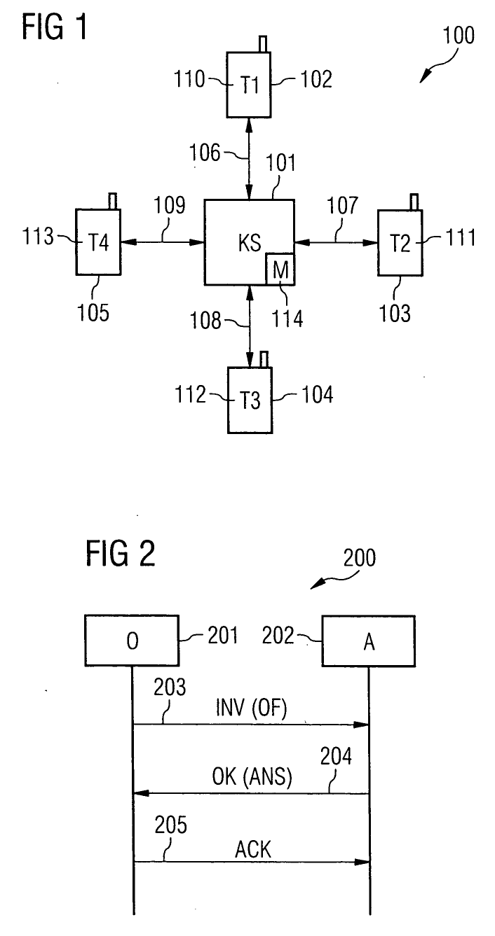

A telecommunication system 100 based on one exemplary embodiment of the invention will be described in the following text with reference to FIG. 1, with t he architecture being in the form of a star.

The telecommunication system 100 has a conference server unit 101, a first telecommunication device 102, a second telecommunication device 103, a third telecommunication device 104, a fourth telecommunication device 105, a signaling link and a data link 106 between the conference server unit 101 and the first telecommunication device 102, a signaling link and data link 107 between the conference server unit 101 and the second telecommunication device 103, a signaling link and data link 108 between the conference server unit 101 and the third telecommunication device 104, a signaling link and data link 109 between the conference server unit 101 and the fourth telecommunication device 105, a first conference participant 110 who is associated with the first telecommunication device 102, a second conference participant 111 who is associated with the second telecommunication device 103, a third conference participant 112 who is associated with the third telecommunication device 104, a fourth conference participant 113 who is associated with the fourth telecommunication device 105, and a moderator unit 114.

The telecommunication system 100 represents a centrally controlled conference, in which the telecommunication devices 102, 103, 104 and 105 do not communicate directly with one another, but communicate with one another via the conference server unit 101, with a telecommunication system 100 such as this being used for so-called “tightly coupled conferencing” in accordance with an IETF Standard, as described in A Framework for Conferencing with the Session Initiation Protocol to Rosenberg, IETF Internet-Draft, October 2004 (“Rosenberg”).

The telecommunication system 100 is designed on the basis of the UMTS architecture that has been described by the 3GPP.

A message flowchart 200 for a n offer-answer model, which is based on the session initiation protocol, will be described in the following text with reference to FIG. 2.

The message flowchart 200 shows a provider 201, a called subscriber 202, a first signaling link 203, a second signaling link 204 and a third signaling link 205, the first signaling link 203 being an “INVITE message” which is transmit ted by means of SIP, the second signaling link 204 being an “OK message” transmitted by means of SIP, and the third signaling link 205 being an “ACK message” transmitted by means of SIP. Communication media formats which are intended for communication are offered by means of the first signaling link 203, with the provider 201 sending an offer OF for the intended communication media formats. By means of the second signaling link 204, the called subscriber 202 uses an OK message to signal those offered communication media formats with which it is compatible. The provider 201 uses the third signaling link 205 to confirm reception of the OK message with an ACK message 205.

As illustrated in FIG. 1, four conference participants 110, 111, 112 and 113 are taking part in the conference, with the conference participants 110, 111, 112 and 113 communicating with one another by means of audio data, video data and text data (text chat). A common communication right is allocated for audio data and video data. A further dedicated communication right is allocated for communication based on text data.

The communication right requests are always sent from the conference participants to the conference server unit 101, with the conference being controlled by the moderator unit 114 which is a machine moderator. The communication right requests are transmitted to the moderator unit 114, and the machine moderator unit 114 decides which of the conference participants 110, 111, 112 and 113 will be granted a communication right. The machine moderator unit 114 then transmits the appropriate signaling messages to the conference participants 110, 111, 112, 113.

The machine moderator unit 114 allocates the communication rights in accordance with the floor policy rules as follows:
at most one conference participant from the conference participants 110, 111, 112, 113 is granted a communication right for each communication medium;
the communication right requests are stored by the machine moderator unit 114 in the sequence of their arrival, with a communication right being granted to that conference participant from the conference participants 110, 111, 112, 113 whose communication right requests were the first to be received by the moderator unit 114;
the communication right per conference participant 110, 111, 112, 1 13 is limited to a predetermined time, preferably 2 minutes, with the moderator unit 114 cancelling this communication right after this time to that conference participant 110, 111, 112, 113 to whom the communication right was previously granted.

The communication between the conference participants 110, 111, 112, 113 and the conference server unit 101 is initialized using the session initiation protocol (SIP) in accordance with the IETF “tightly coupled conferencing”, and the INVITE message 203 is transmitted for this purpose, as shown in FIG. 2, from the provider 201 to the called subscriber 202. The INVITE message 203 is used to offer communication media formats by means of the session description protocol (SDP). This process is carried out by means of the message stream shown in FIG. 2 in accordance with an IETF offer-answer model, which is described in RFC 3550. In the event of an INVITE message 203 for connection initialization by SIP, one of the two ends (i.e., offerer) sends a description of the communication media formats that it supports to the other end ( i.e., answerer). The answerer replies with the descriptions of the communication media formats which are supported by it and have also been offered from the offerer end, with the communication media being described using SDP.

In addition to the SIP signaling, the communication media streams are transmitted by means of the real-time transport protocol (RTP), and the transmission is controlled by the real-time transport control protocol (RTCP).

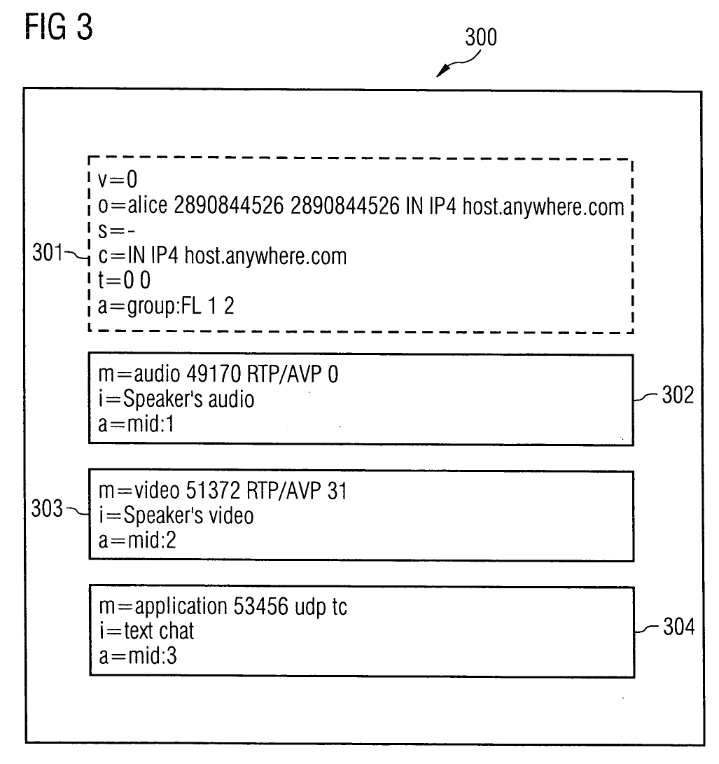

An SDP communication media specification 300 based on the IETF Standard will be described in the following text with reference to FIG. 3.

According to the IETF Standard, which is described in An Offer/Answer Model with the Session Description Protocol (SDP) to Rosenberg, IETF Request for Comments RFC 3264, June 2002, the communication media groupings are defined together with the communication media descriptions by means of SDP, with the communication media groupings being defined by the offer end before a corresponding transmission of communication media data and before a first communication right control command.

The SDP communication media specification 300 has a first block 301, a second block 302, a third block 303 and a fourth block 304, with the first block 301 defining a communication media group. The second block 302, the third block 303 and the fourth block 304 each define different communication media.

The line “a=group” in the first block 301 specifies a communication media group. This line assigns the value “FL 12” to the communication media group attribute, with this value meaning that the communication media streams are grouped with the communication media identifications 1 and 2 for the communication right allocation (FL=Floor Control).

The lines “a=mid” in the second block 302, in the third block 303 and in the fourth block 304 assign identifications to the communication media streams (mid=Media Stream Identification), with the audio data stream of the second block 302 being allocated the identification 1, and the video data stream in the third block 303 being allocated the identification 2.

According to the invention, only communication media streams are grouped. The communication media streams are not grouped together with a floor control channel as has been provided in the past for IETF conference systems for communication right control for communication media groups, as described in Wu.

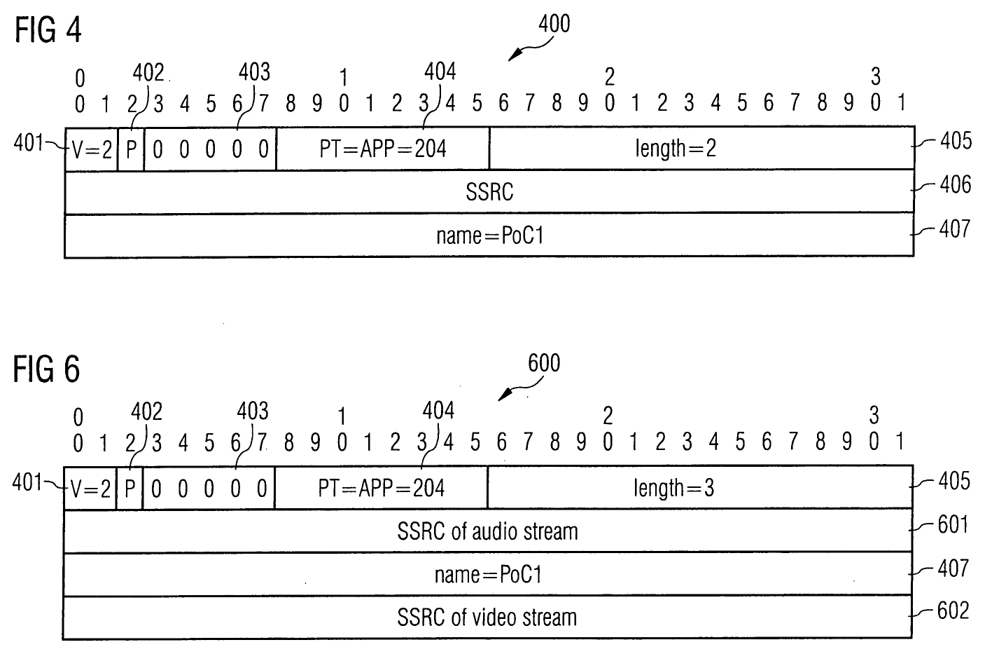

A communication right request message 400 which is designed in accordance with the real-time transport control protocol will be described in the following text with reference to FIG. 4.

The communication right request message 400 has a first field 401, a second field 402, a third field 403, a fourth field 404, a fifth field 405, a sixth field 406 and a seventh field 407. The real-time transport protocol version number V is stated in the first field 401, and an indicator P for the padding is stated in the second field 402, the subtype of the message is indicated in the third field 403, with 00000 indicating that a communication right request (Floor Request) is present, an indicator for application-defined RTCP messages being indicated in the fourth field 404, and the length of the message being indicated in the fifth field 405 after the length field in words with a value of length=2. The sixth field 406 defines the synchronization source of the audio data stream of the transmitter SSRC, with the SSRC uniquely identifying the transmitter and the communication media stream, and with the SSRC being defined in the RTP packets which are associated with the RTCP message 400. The seventh field 407 indicates the application-defined message name, in which case the “name=PoCl” stands for PTT over Cellular Version 1, indicating that communication is by means of a Version 1 push-to-talk system.

In accordance with the standard for modern PTT systems, as is described in Push To-Talk over Cellular (POC) User Plane; Transport Protocols; PoC Release 1.0” by Ericsson, Motorola, Nokia, and Siemens (“PoC Release 1.0”), the data in the communication media streams is transmitted using RTP, with a dedicated data stream being used for each communication medium, and an associated RTCP stream existing for each RTP stream. The RTCP stream is used to interchange control information for the RTP transmission. Furthermore, an RTCP stream is used to transmit the control commands and notifications for control of the communication rights for the communication media streams.

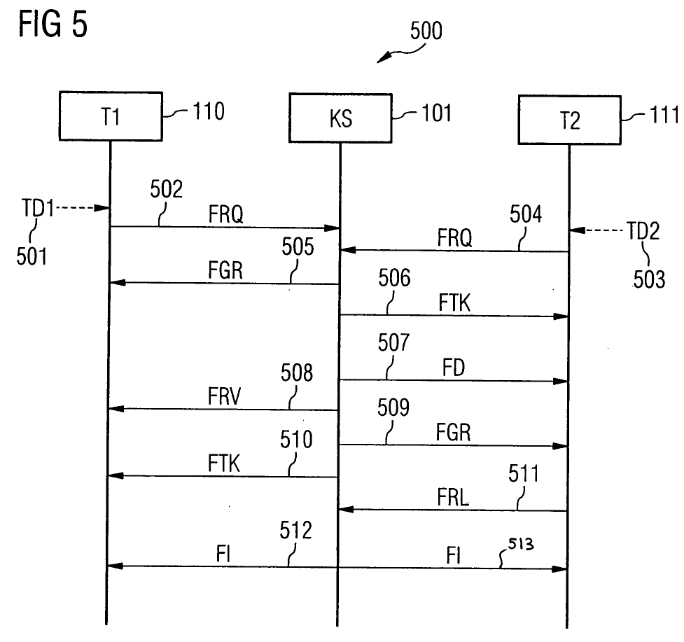

A message flowchart 500 for a communication right controller as used in a PTT system will be described in the following text with reference to FIG. 5, in which case further control commands and notifications for communication right control can be transmitted by means of RTCP, in addition to the request for communication rights.

The message flowchart 500 for a communication right controller shows communication between the conference participant 110 and the conference participant 111 by means of the conference server unit 101. The conference participants 110, 111 request the communication right by means of a floor request message virtually at the same time, with the conference participant 110 operating a key 501 which is designed for this purpose on his telecommunication device 102, and the conference participant 111 operating a key 503 which is designed for this purpose on his telecommunication device 103.

In consequence, a floor request message FRQ 502 is sent from the conference participant 110 to the conference server unit 101, and a floor request message FRQ 504 is sent from the conference participant 111 to the conference server unit 101, with the floor request message FRQ 502 being transmitted by the telecommunication device 102 of the conference participant 110, and the floor request message FRQ 504 being transmitted by the telecommunication device 103 of the conference participant 111. The conference server unit 101 then uses a floor grant message FRG 505 to grant the communication right to the conference participant 110. The conference server unit 101 uses a floor taken message FTK 506 to signal to the conference participant 111 that the communication right has been allocated. A floor deny message FD 507 is then used to signal to the conference participant 111 that his communication right request 504 has been rejected. According to the invention, if the conference participant 110 communicates for longer than the maximum permissible time period (e.g., 2 minutes ), a floor revoke message FRV 508 is sent from the conference server unit 101 to the conference participant 110 to signal that the maximum permissible communication time has been reached, and that the conference server unit 101 is withdrawing the communication right from the conference participant 110. Furthermore, the conference server unit 101 stores the incoming communication right requests in the sequence of their arrival, including those from the conference participant 111, so that the communication right is granted to the conference participant 111 after the communication time of the conference participant 110 has expired, provided that no further request was received from one of the other conference participants before the request from the conference participant 111. The communication right is allocated to the conference participant 111 by means of an FGR message 509, with the conference participant 110 being informed of this by means of an FTK message 510. The conference participant 111 releases the communication right again using a floor release message FRL 511 within the maximum permissible time period for a communication right. The conference server unit 101 uses a floor idle message FI 512, FI 513 to signal to the conference participants 110, 111, respectively, that a communication right is once again available.

This communication right allocation is used for conference systems or PTT systems, in which case the communication right allocation for a group of communication media (e.g., the communication media defined in blocks 302-304) is controlled by means of control commands and notifications of only one RTCP stream for the communication media for the communication media group. The control commands and notifications of the communication medium having the lowest communication media identification (mid) of the respective communication media group (e.g., defined by block 301) control the communication right allocation for the entire communication media group. According to the first exemplary embodiment of the invention, the control commands and the notifications of the audio data stream having mid:1 also control those of the video data stream having mid:2, in which case a communication right is allocated by the moderator unit 114 for this communication media group only when all of the communication media in this communication media group are available.

In contrast, in the prior art, each communication medium is controlled separately by means of individual RTCP messages in a separate communication media data stream. This results in a large amount of data, and inflexible control of the communication media.

In the present invention, it is also possible to provide for control commands and notifications for the communication right control for communication media groups to be transmitted in a plurality of RTCP streams for the communication media. This has the advantage that telecommunication devices which are waiting for the control commands and notifications on all RTCP streams for the requested communication media, since they do not support group control commands, can also be used for the system according to the invention.

According to the invention, RTCP streams other than the RTCP stream which is associated with the communication medium with the lowest SDP communication media identification (mid) can also be used for the transmission of the control commands and notifications for communication right allocation. For example, it is also possible to use the RTCP stream whose communication medium has the highest SDP communication media identification.

Furthermore, it is also possible to provide for only individual communication media in a requested communication media group to be allocated, for example if all of t he communication media in the requested communication media group are not available. The condition for allocation of a communication right is that at least one specific communication medium in the requested communication media group is available. Thus, it is possible to request that at least one communication medium be made available for the RTCP stream for communication right allocation e.g., at least the communication medium with the lowest communication media identification or the communication medium with the highest communication media identification in the respective communication media group be made available.

It is also possible to provide for the communication media to be grouped statically by means of RTCP rather than by means of SDP. Such static grouping by means of RTCP can be carried out, for example, by defining the grouping using the first communication right control command, as in the case of dynamic grouping. According to this embodiment, no communication media grouping is transmitted in any of the control commands and notifications, but the RTCP format is transmitted without the communication media group definition, as illustrated in FIG. 4.

### Exemplary Embodiment 2

The signaling described and the configuration of the telecommunication system as described in the first exemplary embodiment also apply to the second exemplary embodiment.

In the same way as that for the first exemplary embodiment, a conference which is controlled centrally by the conference server unit 101 and has four conference participants 110, 111, 112, 113 will also be considered in the second exemplary embodiment of the invention. Furthermore, the conference participants 110, 111, 112, 113 communicate with one another by means of audio data, video data and text data messages, with the communication rights f or audio data and video data being allocated and controlled jointly. In the same way as in the first exemplary embodiment, communication between the conference participants 110, 111, 112, 113 and the conference server unit 101 is likewise initialized by means of the session initiation protocol, with the communication media descriptions being interchanged and defined by means of the session description protocol. The communication media data streams are also transmitted and controlled by means of the real-time transport protocol and the real-time transport control protocol for the second exemplary embodiment.

In the second exemplary embodiment, the communication media are not combined by means of SDP to form groups Instead, communication media groups are defined with each control command and each notification of the communication right check or communication right control. The control commands and notifications are transmitted by means of RTCP in the same way as in the first exemplary embodiment, using a format for the RTCP messages which has been upgraded in comparison to the formats used in current PTT systems described in PoC Release 1.0. The upgrading of the format comprises additionally attached SSRC fields, with the entry in the field 405 in the RTCP message being increased corresponding to the lengthening of the format. The additional SSRC fields indicate the further RTP communication media data streams to which the communication right control message relates.

An upgraded RTCP message 600 is illustrated in FIG. 6, with the RTCP message 600 having the fields 401, 402, 403, 404, 405 and 407, a modified field 601 and an additional field 602. The fields 401, 402, 403, 404, 405 and 407 correspond to the fields of the RTCP message shown in FIG. 4. Only the entering of the field 405 is adapted in a corresponding manner to the additionally attached fields. According to the second exemplary embodiment of the invention, the SSRC field 601 specifies the synchronization source of the audio data stream of the transmitter, and the SSRC field 602 according to the second exemplary embodiment of the invention specifies the synchronization source of the video data stream of the transmitter, with the SSRC uniquely identifying the transmitter and the communication media data stream. In the same way as in the first exemplary embodiment, the SSRC is defined in the RTP packets which are associated with the RTCP message.

The embodiments mentioned above represent non-restrictive exemplary embodiments of the invention, whose scope of protection is defined by the claims. Modifications are accordingly feasible within the scope of the invention without departing from the area of protection of the claims.

1-17. (canceled)

18. A method for managing the plurality of communication rights of respective telecommunication devices in a telecommunication conference, the method comprising the steps of:
grouping a plurality of communication media to form at least one communication media group using a control communication protocol for controlling a real-time data transmission communication protocol; and
managing the plurality of communication rights of respective telecommunication devices during the telecommunication conference using the control communication protocol for controlling a real-time data transmission communication protocol.

19. The method as set forth in claim 18, wherein the real-time data transmission communication protocol is based on a transport later communication link.

20. The method as set forth in claim 19, where in the transport layer communication link is one of an user datagram protocol communication (UDP) and a transport control protocol communication (TCP).

21. The method as set forth in claim 18, wherein the real-time data transmission communication protocol is a real-time transport protocol (RTP).

22. The method as set forth in claim 18, wherein the control communication protocol for controlling the real-time data transmission communication protocol is a real-time transport control protocol (RTCP).

23. The method as set forth in claim 18, further comprising the step of:
establishing a plurality of connections for respective subscribers of the telecommunication conference in accordance with a call control protocol.

24. The method as set forth in claim 23, wherein the call control protocol is session initiation protocol (SEP).

25. The method as set forth in claim 18, further comprising the step of:
defining a communication media group using a session description protocol (SDP) format.

26. The method as set forth in claim 18, further comprising the step of:
allocating a communication medium prioritization information for each communication medium.

27. The method as set forth in claim 18, further comprising the steps of:
establishing a real-time data transmission communication protocol communication link for using each communication medium;
providing a control communication protocol data stream for each real-time data transmission communication protocol communication link; and
transmitting the control communication protocol data for managing the communication media group via only one of the plurality of control transmission communication protocol data streams.

28. The method as set forth in claim 18, wherein the plurality of communication media comprises an audio data communication medium, a video data communication medium, and a text data communication medium.

29. The method as set forth in claim 18, wherein at least one of the plurality of telecommunication devices is a mobile radio terminal.

30. The method as set forth in claim 18, further comprising the steps of:
assigning at least one floor control channel for each communication media group; and
grouping a plurality of communication media free of the assigned floor control channel.

31. The method as set forth in claim 18, further comprising the steps of:
grouping at least a first communication medium and a second communication medium into a first communication media group;
controlling a first communication medium using a first control command and a first control notification;
controlling a second communication medium using the first control command and first control notification; and
allocating a communication right to the first communication media group only when all of the communication media in the first communication media group are available.

32. A system for managing a plurality of communication rights of each respective telecommunication devices in a telecommunication conference, the system comprising:
a first communication protocol device operable to carry out a real-time data transmission communication protocol;
a second communication protocol device operable to carry out a control communication protocol for controlling the real-time data transmission communication protocol;
a communication media group management unit operable to form at least one communication media group and further operable to control a communication media group that has been formed, the communication media group being grouped and controlled based on the control communication protocol for controlling the real-time data transmission communication protocol; and
a communication right management unit operable to manage the plurality of communication rights of each respective telecommunication device during the telecommunication conference based on the at least one communication media group.

33. The system as set forth in claim 32, further comprising:
a moderator unit operable to allocate the plurality of communication rights based on a floor policy.

34. A method for managing the plurality of communication rights of respective telecommunication devices in a telecommunication conference, the method comprising the steps of:
assigning a relative media stream identification to each of a plurality of communication media;
grouping the plurality of communication media to form at least one communication media group using a control communication protocol for controlling a real-time data transmission communication protocol; and
managing the plurality of communication rights of respective telecommunication devices during the telecommunication conference based on the relative media stream identification of each of the plurality of communication media using the control communication protocol for controlling a real-time data transmission communication protocol.

35. The method as set forth in claim 34, further comprising the steps of:
transmitting a communication right request message from a telecommunication device to a communication rights management server using the real-time data transmission communication protocol; and
including communication media grouping information in the communication right request message using the control communication protocol.

36. The method as set forth in claim 35, further comprising the step of:
using the control communication protocol to transmit control commands and notifications for a communication right control for the communication media group.

37. The method as set forth in claim 34, wherein the real-time data transmission communication protocol is a real-time transport protocol (RTP) and the control communication protocol for controlling the real-time data transmission communication protocol is a real-time transport control protocol (RTCP).
